(19) United States
(12) Patent Application Publication
(10) Pub. No.: US 2002/0046088 A1
(43) Pub. Date: Apr. 18, 2002

(54) Thank-you gift order/dispatch system

(75) Inventor: Shigehito Oba, Tokyo (JP)

Correspondence Address: Milton J Wayne, Burgess Ryan and Wayne, Suite 2105, 370 Lexington Avenue, New York, NY, 10017, US

(73) Assignee: Hiroshi Arai.

(21) Appl. No.: 09/730,256

(22) Filed: Dec. 5, 2000

(30) Foreign Application Priority Data
Aug. 10, 2000 (JP) 242059/2000

(51) Int. Cl. G06F 17/60

(52) U.S. Cl. 705/14; 705/27

(57) ABSTRACT

A thank-you gift order/dispatch system is provided, wherein firstly books of thank-you gifts are distributed to customers attending a ceremony, an event or the like, then the customers notify the thank-you gift information administrator, either through the management of a ceremony or event site or directly, of the names or numbers assigned to chosen thank-you gifts, in succession the thank-you gift information administrator gives an instruction to a thank-you gift dispatch agent based on the names or numbers of said chosen thank-you gifts so that said chosen thank-you gifts are dispatched to the customers.

### BACKGROUND OF THE INVENTION

The present invention relates to a system for processing orders for and dispatching thank-you gifts for ceremonies, such as wedding ceremonies and funerals, celebrations, events, etc.

Thank-you gifts are usually given to attendants after the host of a ceremony or event and the management of a ceremony or event site consult with each other and decide on the thank-you gifts.

With such a conventional method, thank-you gifts are decided on regardless of the wishes attendants may have.

However, it is possible that disappointing gifts may be given to a considerable number of attendants according to this method, in which case the true intention of the thank-you gifts can not be attained sufficiently.

Therefore, the present invention aims at providing a configuration of a system which overcomes the above-mentioned disadvantage and makes it possible for customers, who are attendants, to choose the thank-you gifts they would like to receive, and providing a system used within the above-mentioned system for ex post facto processing for customers to choose thank-you gifts even after a predetermined period.

### SUMMARY OF THE INVENTION

To solve the problem above, the present invention consists of a system wherein firstly books of thank-you gifts are distributed to customers attending a ceremony, an event or the like, then the customers notify the thank-you gift information administrator, either through the management of a ceremony or event site or directly, of the names or numbers assigned to chosen thank-you gifts, in succession the thank-you gift information administrator gives an instruction to a thank-you gift dispatch agent based on the names or numbers of the chosen thank-you gifts, and the chosen thank-you gifts are dispatched to the customers.

### BRIEF DESCRIPTION OF THE DRAWINGS

FIG. 1 is a flow chart showing a judgement process executed by a computer in an embodiment of the present invention;

FIG. 2 is a flow chart showing a judgement process executed by a computer in other embodiment of the present invention; and

FIG. 3 is a block diagram showing a basic configuration of the present invention.

### DETAILED DESCRIPTION OF THE INVENTION

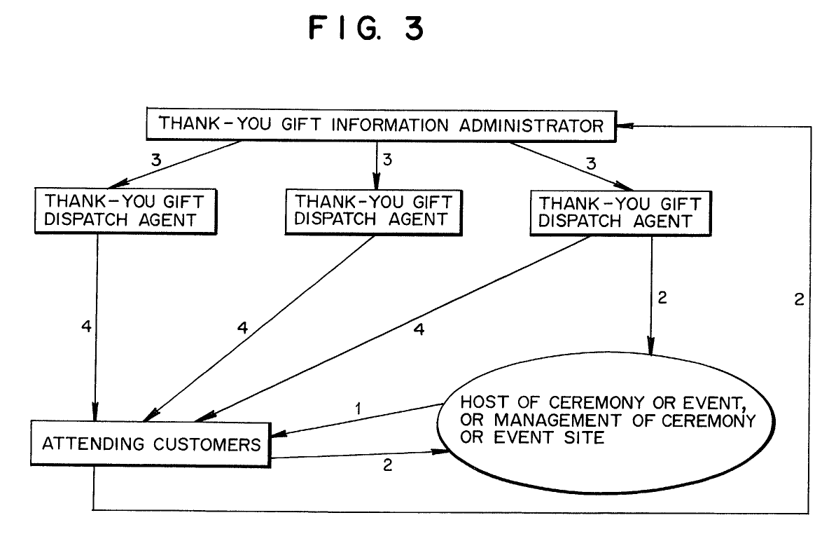

As shown in FIG. 3 illustrating a basic configuration of the present invention, the present invention is directed to a system wherein books of thank-you gifts are distributed to customers which are attendants (process 1), the customers notify the thank-you gift information administrator, either directly or through the management of a ceremony or event site, of the names or numbers assigned to thank-you gifts which the customers chose based on the books (process 2), the thank-you gift information administrator gives an instruction to a thank-you gift dispatch agent to dispatch the chosen thank-you gifts (process 3), and the thank-you gift dispatch agent dispatches the thank-you gifts to the customers (process 4).

With such a system according to the present invention, customers attending a ceremony or an event can choose from thank-you gifts contained in books and receive the chosen thank-you gifts, and therefore, it is possible to avoid the inconvenience of a conventional method of distributing thank-you gifts which is that the customers may have to accept disappointing gifts.

In the basic configuration as described above, a scheme for communicating the names or numbers assigned to thank-you gifts chosen by customers may use not only post cards as is customarily practiced but various other communication methods such as facsimile, telephone and e-mail.

However, in the basic configuration as described above, if a customer who brought back a book fails to choose a thank-you gift or communicate regarding the chosen gift via a post card or the like after a certain period, a basic problem occurs wherein a thank-you gift can not be delivered to the customer.

In the basic configuration described above, usually, prices in proportion to respective customers are paid to a thank-you gift information administrator by a host of a ceremony or event or the management of a ceremony or event site, and prices in proportion to the thank-you gifts to be dispatched are paid to a thank-you gift dispatch agent by the thank-you gift information administrator.

To deal with such a situation a specific aspect of the present invention adopts a concrete configuration wherein

(1) the thank-you gift information administrator stores information regarding at least the addresses and names of customers in a computer memory in advance, and in the event that a customer fails to communicate regarding the name or number of a chosen thank-you gift even after a predetermined period, the administrator makes an enquiry to the customer, based on an output signal from a computer, about whether this customer intends to receive a thank-you gift or not and the name or number of a chosen thank-you gift if the customer plans to receive the thank-you gift; or the thank-you gift information administrator stores information regarding at least the addresses and names of customers in a computer memory in advance, and in the event that a customer fails to communicate regarding the name or number of a chosen thank-you gift even after a predetermined period, has a thank-you gift, chosen by the thank-you gift information administrator, dispatched to this customer based on an output signal from a computer.

In short, in the system according to the aspect (1), an enquiry is made regarding whether this customer intends to choose a thank-you gift and communicate the choice.

In a system according to the aspect (2), a thank-you gift chosen by the thank-you gift information administrator is dispatched from the thank-you gift dispatch agent. Hence, in each one of the aspects, it is possible to overcome the problem addressed by the present invention.

According to aspects (1) and (2) above, while a certain number of days counted from the date of an event is set as the predetermined period in many instances, the number of days in the predetermined period is recorded in the computer memory as a necessity, and whether the predetermined period has elapsed or not is determined with respect to the respective recorded customers if necessary.

Thus, the aspects (1) and (2) as such allow an obstacle to be overcome which is caused when a customer who is an attendant does not choose a thank-you gift.

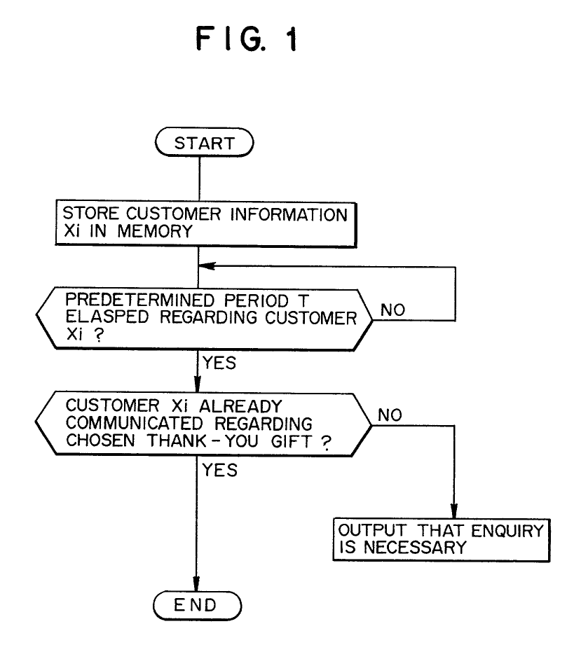

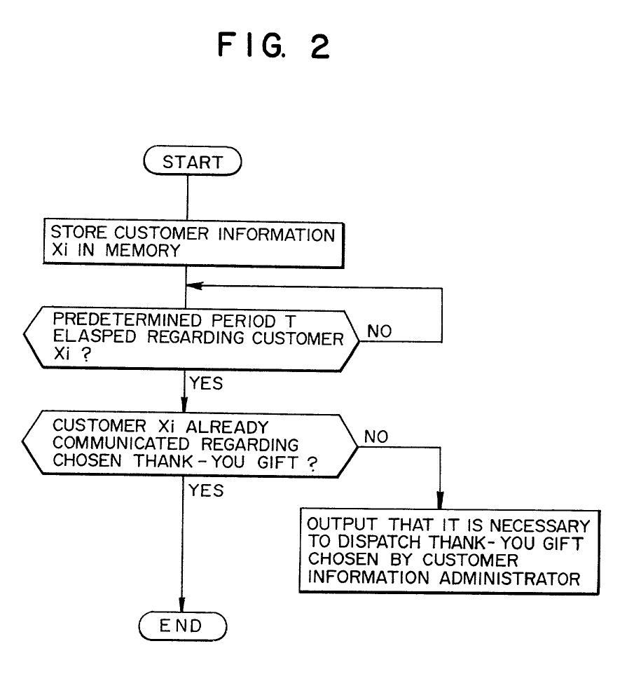

A flow chart regarding how a computer makes judgement in the system according to aspect (1) is as shown in FIG. 1, and a flow chart regarding how a computer makes judgement in the system the system according to aspect (2) is as shown in FIG. 2.

In the system according to aspect (1), if a customer who fails to select or communicate gives a reply that the customer does not want a thank-you gift to an enquiry or the customer fails to reply even after a certain period after the enquiry, an administrative process regarding this customer is stopped, whereas if the customer replies in response to the enquiry regarding the name or number of a chosen thank-you gift, the chosen thank-you gift is dispatched from the thank-you gift dispatch agent. (When the enquiry is made via a post card or the like, the “certain period” may be set based on the date of the dispatch of the letter of enquiry regarding the “certain period,” or alternatively, the date of delivery of the letter of enquiry.)

Meanwhile, in system (2), instead of inquiring as in situation (1), a thank-you gift chosen by the thank-you gift information administrator is dispatched to a customer from the thank-you gift dispatch agent, a response from the customer is awaited.

The administrative process regarding this customer is stopped if the customer still fails to communicate within the further certain period, whereas if on the contrary, the customer, finding the thank-you gift sent during the certain period does not match the customer's wishes has, communicates information concerning a thank-you gift wanted by the customer, it is possible to dispatch the thank-you gift chosen by the customer later from the thank-you gift dispatch agent in exchange for the already dispatched thank-you gift. (The “certain period” may be set based on the date of the dispatch of the thank-you gift or the date of delivery of the thank-you gift to the customer.)

As described above, while the minimum necessary information regarding customers is the addresses and the names of the customers, if preferences, characteristics or the like of the customers are known in addition to these, such information as well may be stored, which can be often used as reference for the thank-you gift information administrator to choose thank-you gifts in system (2).

In the following, specific embodiments which are common throughout the present invention will be described.

[Embodiment 1]

In many cases thank-you gifts are provided in proportion to the amounts of money presented by attendants to a ceremony or event.

In such a case, it would not be fair if a host selects thank-you gifts regardless of the amount of money presented.

Embodiment 1, noting this, is characterized in that a host considers the amount of money given by a customer who is an attendant and classifies thank-you gift books in accordance with the amount of money or range of the amount of money.

For example, a book A contains thank-you gifts whose value is a dollars or in a range from a₁ to a₂ dollars, a book B contains thank-you gifts whose value is b dollars or ranges from b₁ dollars to b₂ dollars, and a book C contains thank-you gifts whose value is c dollars or ranges from c₁ dollars to c₂ dollars, and the books to be distributed to the customers are selected in accordance with the amounts of money given by the customers.

Selection as such makes it possible to provide thank-you gifts whose monetary values are proportioned approximately to the amounts of money given by the customers.

[Embodiment 2]

While attending customers are scattered nationwide in some situations, the attending customers are limited to a particular region in other, situations, or alternatively, an intermediately situation between the two is also possible. In any situation, the thank-you gift dispatch agents are present only in particular areas.

According to embodiment 2, thank-you gift dispatch agents are classified nationwide (e.g., in states X, Y, Z, . . . ), and therefore, it is possible to dispatch thank-you gifts from a thank-you gift dispatch agent who corresponds to the location of customers.

With thank-you gift dispatch agents classified nationwide in such a manner, it is possible to reduce transportation costs for delivering thank-you gifts.

[Embodiment 3]

In general, thank-you gifts often vary greatly, ranging from garments, foodstuffs, and furniture to personal items.

On the other hand, a thank-you gift dispatch agent is simultaneously a manufacturer a wholesaler in some cases. In the case of such an agent, the agent is generally specialized in the items the agent deals with, and therefore, does not necessarily have a great variety of thank-you gifts.

In embodiment 3, different dispatch agents are engaged together in accordance with the types of thank-you gifts.

That is, a dispatch agent A is used for garments, a dispatch agent B is used for furniture, a dispatch agent C is used for foodstuffs, and a dispatch agent D is used for personal items. Based on instructions given from a thank-you gift information administrator, requested thank-you gifts are dispatched to customers in accordance with instructions from a computer.

### EFFECTS OF THE INVENTION

In a system as described above according the present invention, attending customers can make their own decision as regards what thank-you gift to receive.

According to aspects (1) and (2) above, and in particular to deal with a customer who fails to choose a thank-you gift and communicate their choice after a certain period, a further enquiry is made or a thank-you gift chosen by a thank-you gift information administrator is dispatched, thereby completing the administrative process.

In this case, the system according to the present invention is innovative and tremendously valuable in that the system overcomes a deficiency with the conventional delivery of thank-you gifts.

What is claimed is:

1. A thank-you gift order/dispatch system, wherein firstly books of thank-you gifts are distributed to customers attending a ceremony, an event or the like, then the customers notify the thank-you gift information administrator, either through the management of a ceremony or event site or directly, of the names or numbers assigned to chosen thank-you gifts, in succession the thank-you gift information administrator gives an instruction to a thank-you gift dispatch agent based on the names or numbers of said chosen thank-you gifts so that said chosen thank-you gifts are dispatched to the customers.

2. The thank-you gift order/dispatch system of claim 1, wherein said thank-you gift information administrator stores information regarding at least the addresses and names of the customers in a computer memory in advance, and in the event that a customer fails to communicate regarding the name or number of a chosen thank-you gift even after a predetermined period, the administrator makes an enquiry to the customer, based on an output signal from a computer, regarding whether the customer intends to receive a thank-you gift or not and the name or number of a chosen thank-you gift if the customer intends to receive the thank-you gift.

3. The thank-you gift order/dispatch system of claim 2, wherein if the customer still fails to reply within a certain period, said thank-you gift information administrator stops the administrative process regarding the customer.

4. A thank-you gift order/dispatch system characterized in that a thank-you gift information administrator stores information regarding at least the addresses and names of customers in a computer memory in advance, and in the event that a customer fails to communicate regarding the name or number of a chosen thank-you gift even after a predetermined period, a thank-you gift chosen by said thank-you gift information administrator is dispatched to the customer based on an output signal from a computer.

5. The thank-you gift order/dispatch system of claim 4, wherein in the event that the customer still fails to reply within a further certain period since dispatch of the thank-you gift chosen by said thank-you gift information administrator from a thank-you gift dispatch agent, said thank-you gift information administrator stops the administrative process regarding the customer.

6. The thank-you gift order/dispatch system of claims 1, 2 and 4, wherein the books to be distributed are different from each other in terms of the prices of the thank-you gifts or price ranges of the thank-you gifts.

7. The thank-you gift order/dispatch system of claim 1, 2 and 4, wherein thank-you gift dispatch agents are classified by region.

8. The thank-you gift order/dispatch system of claim 1, 2 and 4, wherein thank-you gift dispatch agents are different from each other in accordance with the types of thank-you gifts.
